(19) United States
(12) Patent Application Publication
(10) Pub. No.: US 2025/0073815 A1
(43) Pub. Date: Mar. 6, 2025

(54) ANNULAR WATER CURTAIN COMBINED WATER-JET GUIDED LASER MACHINING DEVICE AND METHOD

(71) Applicant: HARBIN WELDING INSTITUTE LIMITED COMPANY, Harbin, Heilongjiang (CN)

(72) Inventors: Ruisheng HUANG, Harbin, Heilongjiang (CN); Qian SUN, Harbin, Heilongjiang (CN); Nannan HE, Harbin, Heilongjiang (CN); Rong LI, Harbin, Heilongjiang (CN); Xiaomei LIANG, Harbin, Heilongjiang (CN); Hao CAO, Harbin, Heilongjiang (CN); Pengbo HAN, Harbin, Heilongjiang (CN)

(21) Appl. No.: 18/293,914

(22) PCT Filed: Nov. 14, 2023
(86) PCT No.: PCT/CN2023/131391

§ 371 Date: Jan. 31, 2024

(30) Foreign Application Priority Data
Aug. 28, 2023 (CN) 202311087514.0

(51) Int. Cl. B23K 26/14; B23K 26/146

(52) U.S. Cl. CPC B23K 26/1464; B23K 26/146

(57) ABSTRACT

The present disclosure provides an annular water curtain combined water-jet guided laser machining device and method of using the same. The annular water curtain combined water-jet guided laser machining device includes a laser-water coupling device, an annular water jet device, a nozzle, and an annular nozzle. The nozzle is arranged at a lower end of the laser-water coupling device. The annular nozzle is arranged on the annular water jet device. The nozzle is coaxially arranged in the annular nozzle. The laser-water coupling device is used for coupling a laser beam with high-pressure water and spraying a laser guiding water jet from the nozzle. The annular water jet device is used for spraying high-pressure water from the annular nozzle to form an annular water curtain surrounding the laser guiding water jet. It is mainly used for precision hot machining such as cutting, punching and grooving.

### CROSS-REFERENCE TO RELATED APPLICATION

This application is a national stage application of International Patent Application No. PCT/CN2023/131391, filed Nov. 14, 2023, which claims priority of the Chinese Patent Application No. 202311087514.0, filed on Aug. 28, 2023, both of which are incorporated by references in their entities.

### TECHNICAL FIELD

The present disclosure belongs to the field of machining, in particular to an annular water curtain combined water-jet guided laser machining device and method.

### BACKGROUND

In high-end manufacturing enterprises for aerospace equipment, medical equipment and semiconductor micromachining, the technical requirements for machining precision, efficiency, thermal damage, and fracture quality are extremely high in the manufacturing of many key precision components, and it is difficult for conventional machining methods to effectively meet the above requirements.

Water-jet guided laser technology is a green, efficient, and precision machining technology. The principle of the technology is as follows: coupling a high-energy laser beam into a fine water jet, and guiding the laser to a surface of a workpiece by the water jet to perform precision hot working such as cutting, punching or grooving on the workpiece, while excess heat and residue are taken away by the water jet. Therefore, water-jet guided laser technology can achieve precise control of high-density energy in a “cold and heat source” mode, and ultra-precise, efficient, and high-quality notches are obtained. Water-jet guided laser technology is very suitable for fine machining of high-temperature alloy, wafers, carbon fibers, and other materials, as well as machining of components for biomedical instruments.

The precision machining capability of water-jet guided laser is determined by two key factors, namely the diameter of the water jet and the stable length of the water jet. Because the diameter of the water jet in water-jet guided laser has a great influence on machining accuracy, the smaller the diameter of a nozzle, the smaller the diameter of the water jet sprayed, and the higher the machining accuracy. In addition, the machining depth and machining distance of the water-jet guided laser depend on the length of the stable laser guiding water jet, that is, the length of the jet segment with the best laser guiding effect in the laser guiding water jet. The jet segment has the characteristics of a bright, clean and smooth surface, and a liquid flow in a compact cylindrical shape. Therefore, the two technical indicators are extremely concerned in the industry. However, it is difficult to achieve simultaneous enhancement of the two indicators. The high-pressure water jet is subjected to intense friction with the surrounding air after being sprayed from the nozzle, resulting in a gradual disturbance of the internal stable laminar flow state. Therefore, the water jet becomes unstable after being sprayed for a certain distance, breaks into water droplets, and the channel for coupling laser with water is destroyed. Research has shown that the smaller the diameter of the water jet, the greater the influence, and the shorter the length of the stable water jet. Even if some researchers have applied an auxiliary atmosphere at the nozzle of the water jet to isolate air and increase the length of stable liquid flow to some extent, the distance for the auxiliary atmosphere to maintain a compact state after being sprayed is also extremely limited, and the protection is ineffective when the auxiliary atmosphere spreads for a certain distance. Therefore, how to effectively increase a length of the stable water jet, especially in the case of a water jet with small diameter, it is of great help to effectively improve the machinable range, incision quality, efficiency, and promotion of water-jet guided laser technology.

### SUMMARY

In view of this, the present disclosure aims to provide an annular water curtain combined water-jet guided laser machining device and method so as to solve the problem that a length of a stable water jet cannot be prolonged during machining in the water-jet guided laser technology.

In order to achieve the above purpose, according to one aspect of the present disclosure, an annular water curtain combined water-jet guided laser machining device is provided. The device includes a laser-water coupling device, an annular water jet device, a nozzle, and an annular nozzle. The nozzle is arranged at a lower end of the laser-water coupling device. The annular nozzle is arranged on the annular water jet device. The nozzle is coaxially arranged in the annular nozzle. The laser-water coupling device is configured for coupling a laser beam with high-pressure water and spraying a laser guiding water jet from the nozzle. The annular water jet device is configured for spraying high-pressure water from the annular nozzle to form an annular water curtain surrounding the laser guiding water jet.

Further, an isolation space is enclosed between the laser guiding water jet and the annular water curtain.

Further, the annular water jet device is connected to the lower end of the laser-water coupling device.

Further, high-pressure water inlets are formed in both the laser-water coupling device and the annular water jet device.

Further, a laser emitting device for emitting the laser beam into the laser-water coupling device is arranged at an upper end of the laser-water coupling device.

Further, the laser beam includes a single energy beam or a combination energy beam.

Further, a diameter of the laser guiding water jet is in a range of 10-600 μm, and a pressure of water is in a range of 0-100 MPa.

Further, an inner diameter of the annular water curtain is in a range of 2 mm to 50 mm, a flow width of the annular water curtain is in a range of 30 μm to 8 mm, and a flow rate of the annular water curtain is in a range of 0.01 to 10 times of a flow rate of the laser guiding water jet.

Further, the high-pressure water includes purified water, distilled water, or other liquids meeting the requirements for guiding laser.

According to another aspect of the present disclosure, a method of using the annular water curtain combined water-jet guided laser machining device is provided, and the method includes the following steps:

Step 1, spraying, from a nozzle, water in the laser-water coupling device at a high speed under pressure to form a single water jet;

step 2, spraying, from the annular nozzle, water in the annular water jet device under pressure to form an annular water curtain surrounding the single water jet with a certain gap between the annular water curtain and the single water jet; and

step 3, coupling the laser beam into the single water jet to form a laser guiding water jet, and spraying the laser guiding water jet, together with the annular water curtain, onto a surface of a workpiece to be machined for machining.

Compared with the prior art, the present disclosure achieves the following beneficial effects:
1. In the present disclosure, another annular water curtain is coaxially combined outside the laser guiding water jet to form an isolation space, the annular water curtain is not involved in the hot working process, but the isolation space can protect the laser guiding water jet. By such design, the influence of an external gas environment on the isolation space can be effectively eliminated, so that the laser guiding water jet at the central is always in a static environment, and the anti-interference performance and stability of the laser guiding water jet can be effectively improved.
2. In the present disclosure, the annular water curtain can drive the gas in the isolation space to move in the same direction as the annular water curtain through a friction effect on the surrounding gas, and the annular water curtain is combined with the laser guiding water jet coaxially and in the same direction, so the gas in the isolation space also flows in the same direction with the laser guiding water jet. Therefore, after being sprayed, a speed of the laser guiding water jet relative to the surrounding gas is greatly reduced, the friction effect between the laser guiding water jet and the surrounding gas is also significantly weakened, so that the stability of the laser guiding water jet is enhanced, and the length of the stable laser guiding water jet is effectively prolonged.
3. In the present disclosure, the annular water curtain can form an isolation space and can drive gas in the isolation space to move directionally, so that a certain negative pressure effect can be achieved in the isolation space. Since a pressure difference between an internal and external of the nozzle is increased, a spraying speed of the laser guiding water jet at an opening of the nozzle is increased. In addition, since the negative pressure in the isolation space also means that the amount of the surrounding gas is reduced, the resistance of the surrounding gas to the laser guiding water jet is reduced, and the length of the stable liquid flow of the laser guiding water jet is further increased.
4. In the present disclosure, the effect that the length of the stable jet flow is effectively prolonged can be achieved, and the effect can still be obvious in the case of a water jet with small diameter. In addition, the increase of the length of the stable jet flow is helpful for improving the machinable range, incision quality, machining efficiency, and other aspects of the water-jet guided laser technology.
5. In the present disclosure, through the machining way with the water curtain, excess machining heat and cutting residues can be effectively taken away. Therefore, the heat affected zone of the obtained notches is smaller and the quality of the notches is better.
6. The annular water jet device is simple in structure, convenient in installation, easy to implement, and has more combined beneficial effects, obvious effects and good practicability.
7. Compared with the conventional method of applying an auxiliary atmosphere at the nozzle, the design of the annular water curtain in the present disclosure has the advantages that because the density of water is much higher than that of gas, the impulse of the annular water curtain sprayed is larger than that of the auxiliary atmosphere, the annular water curtain is less likely to be affected by the surrounding atmosphere, resulting in the destruction of the spraying form. Therefore, the isolation space formed by the annular water curtain has better stability and compactness than that formed by the auxiliary atmosphere, and the distance of effective protection is longer, so the isolation effect on external gas is better, and the stability of hot working is better. The molecular density of the annular water curtain is close to or same as that of the laser guiding water jet, so the change of the movement speed of the annular water curtain is close to that of the laser guiding water jet in the falling process. Therefore, even after the laser guiding water jet is sprayed for a long distance, the surrounding gas can still keep a less movement relative to the laser guiding water jet under the drive of the annular water curtain. In the method of applying an auxiliary atmosphere, the difference between a flow field of the surrounding gas around the nozzle and a flow field of the surrounding gas after the laser guiding water jet is sprayed for a certain distance is great, resulting in changes in the state of the liquid flow. Therefore, through the design of the annular water curtain, it is more conducive to achieve a significant increase of the length of the stable water jet.
8. Since the liquid sprayed from the annular water curtain can be recycled, so compared with the method of applying an auxiliary atmosphere, the method in the present disclosure can save more resources and can be more environmentally friendly.

### BRIEF DESCRIPTION OF THE DRAWINGS

Drawings as a part of the present disclosure are used for providing further understanding of the present disclosure. Exemplary embodiments and description of the exemplary embodiments in the present disclosure are used for explaining the present disclosure and are not construed as a limitation to the present disclosure. In drawings,

FIG. 1 is a schematic diagram of a structure of an annular water curtain combined water-jet guided laser machining device in the present disclosure.

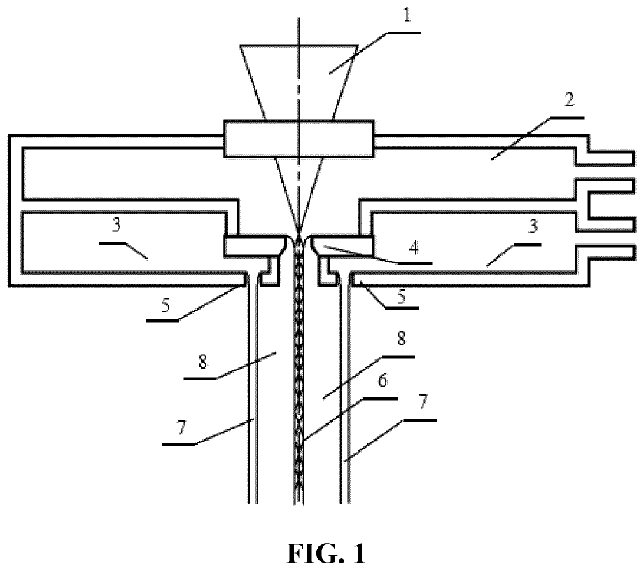

Reference signs: 1 laser beam; 2 laser-water coupling device; 3 annular water jet device; 4 nozzle; 5 annular nozzle; 6 laser guiding water jet; 7 annular water curtain; and 8 isolation space.

### DETAILED DESCRIPTION OF THE EMBODIMENTS

The following clearly and completely describes the technical solutions in the embodiments of the present disclosure with reference to the drawings in the embodiments of the present disclosure. It should be noted that, without conflict, the embodiments in the present disclosure and characteristics in the embodiments can be combined with each other. The described embodiments are only a part of the embodiments of the present disclosure, but not the whole embodiments.

The embodiment is described with reference to the drawings. According to one aspect of the present disclosure, an annular water curtain combined water-jet guided laser machining device is provided. The device includes a laser-water coupling device 2, an annular water jet device 3, a nozzle 4, and an annular nozzle 5. The nozzle 4 is arranged at a lower end of the laser-water coupling device 2. The annular nozzle 5 is arranged on the annular water jet device 3. The nozzle 4 is coaxially arranged in the annular nozzle 5. The laser-water coupling device 2 is used for coupling a laser beam 1 with high-pressure water and spraying a laser guiding water jet 6 from the nozzle 4. The annular water jet device 3 is used for spraying high-pressure water from the annular nozzle 5 to form an annular water curtain 7 surrounding the laser guiding water jet 6. The traditional laser guiding water jet 6 is subjected to intense friction with the surrounding air in the cutting process, resulting in a gradual disturbance of the internal stable laminar flow state. Therefore, the water jet becomes unstable after being sprayed for a certain distance, breaks into water droplets, and the channel for coupling laser with water is destroyed. The laser guiding water jet 6 can be surrounded by the annular water curtain 7 sprayed from the coaxially arranged annular nozzle 5, and thus an isolation space 8 is enclosed between the laser guiding water jet 6 and the annular water curtain 7. In addition, gas in the isolation space 8 can be driven to move directionally, since a movement direction of the gas is the same as that of the laser guiding water jet 6 and a flow rate of the gas is close to that of the laser guiding water jet 6, an interaction between the two is quite small, playing a main effect in stabilizing the water jet. Meanwhile, a certain negative pressure effect can be achieved in the isolation space 8, since a pressure difference between an internal and external of the nozzle 4 is increased, a spraying speed of the laser guiding water jet 6 at an opening of the nozzle 4 is increased. In addition, since the negative pressure in the isolation space 8 also means that the amount of surrounding gas is reduced, the resistance of the surrounding gas to the laser guiding water jet 6 is reduced, and the length of the stable liquid flow of the laser guiding water jet 6 is further increased. Therefore, the length of the stable water jet can be effectively increased, and a good prolonging effect can still be achieved even in the case of a water jet with small diameter.

In this embodiment, the annular water jet device 3 is connected to the lower end of the laser-water coupling device 2. By integrating the annular water-jet device 3 with the laser-water coupling device 2, space can be reduced, and it is more conducive to arrange the nozzle 4 coaxially with the annular nozzle 5. A flange is arranged at a lower end of the nozzle 4, and a stable annular water curtain 7 can be formed by combining the flange with the annular nozzle 5.

In this embodiment, high-pressure water inlets are formed in both the laser-water coupling device 2 and the annular water jet device 3. In this arrangement, hydraulic pressure in the laser-water coupling device 2 and the annular water-jet device 3 can be controlled separately, and thus the independent regulation of the laser guiding water jet and the annular water curtain jet can be realized. The high-pressure water inlets of the laser-water coupling device 2 and the annular water-jet device 3 can be arranged on the same side to facilitate installation, and the arrangement of high-pressure water pipelines is also more reasonable.

In this embodiment, a laser emitting device configured for emitting the laser beam 1 into the laser-water coupling device 2 is arranged at an upper end of the laser-water coupling device 2.

In this embodiment, the laser beam 1 includes a single energy beam or a combination energy beam. The water-jet guided laser machining device can adapt to different types of laser beams, and is high in universality. The device can be realized by installing different types of laser emitters.

In this embodiment, a diameter of the laser guiding water jet 6 is in a range of 10-600 μm, and a pressure of the water is in a range of 0-100 MPa.

In this embodiment, an inner diameter of the annular water curtain 7 is in a range of 2 mm to 50 mm, a flow width of the annular water curtain is in a range of 30 μm to 8 mm, and a flow rate of the annular water curtain is in a range of 0.01 to 10 times of a flow rate of the laser guiding water jet 6. In this arrangement, laser guiding water jet 6 is enclosed in the annular water curtain, and a good and normal cutting effect can still be ensured in case that the annular water curtain 7 is slightly offset towards the laser guiding water jet 6.

In this embodiment, the high-pressure water includes purified water, distilled water, or other liquids meeting the requirements for guiding laser.

According to another aspect of the present disclosure, a method of using the annular water curtain combined water-jet guided laser machining device is provided. The method includes the following steps:

Step 1, water in the laser-water coupling device 2 is sprayed from the nozzle 4 at a high speed under pressure to form a single water jet;

Step 2, water in the annular water jet device 3 is sprayed from the annular nozzle 5 under pressure to form an annular water curtain 7 surrounding the single water jet with a certain gap between the annular water curtain 7 and the single water jet; the annular water curtain 7 can drive the gas in the isolation space to move in the same direction as the annular water curtain through a friction effect on the surrounding gas, and the annular water curtain is combined with the laser guiding water jet coaxially and in the same direction, so the gas in the isolation space also flows in the same direction with the laser guiding water jet; therefore, after being sprayed, a speed of the laser guiding water jet relative to the surrounding gas is greatly reduced, the friction effect between the laser guiding water jet and the surrounding gas is also significantly weakened, so that the stability of the laser guiding water jet is enhanced, and the length of the stable laser guiding water jet is effectively prolonged; and

Step 3, the laser beam 1 is coupled into the single water jet to form a laser guiding water jet 6, and the laser guiding water jet 6 together with the annular water curtain 7 is sprayed onto a surface of a workpiece to be machined for machining, so that excess machining heat and cutting residues are effectively taken away; therefore, the heat affected zone of the obtained notches is smaller and the quality of the notches is better.

The embodiments of the present disclosure disclosed above are merely to help illustrate the present disclosure. The embodiments neither fully recite all the details nor limit the present disclosure merely to the specific embodiments described. Many modifications and variations can be implemented according to the contents of the specification. These embodiments are chosen and specifically described in the specification in order to better explain the principles and the practical application of the present disclosure, so that those skilled in the art can understand and utilize the present disclosure better.

What is claimed is:

1. An annular water curtain combined water-jet guided laser machining device, wherein the device comprises a laser-water coupling device (2), an annular water jet device (3), a nozzle (4), and an annular nozzle (5), the nozzle (4) is arranged at a lower end of the laser-water coupling device (2), the annular nozzle (5) is arranged on the annular water jet device (3), the nozzle (4) is coaxially arranged in the annular nozzle (5), the laser-water coupling device (2) is configured for coupling a laser beam (1) with high-pressure water and spraying a laser guiding water jet (6) from the nozzle (4), the annular water jet device (3) is configured for spraying high-pressure water from the annular nozzle (5) to form an annular water curtain (7) surrounding the laser guiding water jet (6).

2. The annular water curtain combined water-jet guided laser machining device according to claim 1, wherein an isolation space (8) is enclosed between the laser guiding water jet (6) and the annular water curtain (7).

3. The annular water curtain combined water-jet guided laser machining device according to claim 1, wherein the annular water jet device (3) is connected to the lower end of the laser-water coupling device (2).

4. The annular water curtain combined water-jet guided laser machining device according to claim 1, wherein high-pressure water inlets are formed in both the laser-water coupling device (2) and the annular water jet device (3).

5. The annular water curtain combined water-jet guided laser machining device according to claim 1, wherein a laser emitting device configured for emitting the laser beam (1) into the laser-water coupling device (2) is arranged at an upper end of the laser-water coupling device (2).

6. The annular water curtain combined water-jet guided laser machining device according to claim 1, wherein the laser beam (1) includes a single energy beam or a combination energy beam.

7. The annular water curtain combined water-jet guided laser machining device according to claim 1, wherein a diameter of the laser guiding water jet (6) is in a range of 10-600 μm, and a pressure of water is in a range of 0-100 MPa.

8. The annular water curtain combined water-jet guided laser machining device according to claim 6, wherein an inner diameter of the annular water curtain (7) is in a range of 2 mm to 50 mm, a flow width of the annular water curtain is in a range of 30 μm to 8 mm, and a flow rate of the annular water curtain is in a range of 0.01 to 10 times of a flow rate of the laser guiding water jet (6).

9. The annular water curtain combined water-jet guided laser machining device according to claim 1, wherein the high-pressure water includes purified water, distilled water, or other liquids meeting requirements for guiding laser.

10. A method of using the annular water curtain combined water-jet guided laser machining device, wherein the device comprises a laser-water coupling device (2), an annular water jet device (3), a nozzle (4), and an annular nozzle (5), the nozzle (4) is arranged at a lower end of the laser-water coupling device (2), the annular nozzle (5) is arranged on the annular water jet device (3), the nozzle (4) is coaxially arranged in the annular nozzle (5), the laser-water coupling device (2) is configured for coupling a laser beam (1) with high-pressure water and spraying a laser guiding water jet (6) from the nozzle (4), the annular water jet device (3) is configured for spraying high-pressure water from the annular nozzle (5) to form an annular water curtain (7) surrounding the laser guiding water jet (6), the method comprises the following steps:
Step 1, spraying, from a nozzle (4), water in the laser-water coupling device (2) at a high speed under pressure to form a single water jet;
Step 2, spraying, from the annular nozzle (5), water in the annular water jet device (3) under pressure to form an annular water curtain (7) surrounding the single water jet with a certain gap between the annular water curtain (7) and the single water jet; and
Step 3, coupling the laser beam (1) into the single water jet to form a laser guiding water jet (6), and spraying the laser guiding water jet (6), together with the annular water curtain (7), onto a surface of a workpiece to be machined for machining.

11. A method of using the annular water curtain combined water-jet guided laser machining device according to claim 10, wherein an isolation space (8) is enclosed between the laser guiding water jet (6) and the annular water curtain (7).

12. A method of using the annular water curtain combined water-jet guided laser machining device according to claim 10, wherein the annular water jet device (3) is connected to the lower end of the laser-water coupling device (2).

13. A method of using the annular water curtain combined water-jet guided laser machining device according to claim 10, wherein high-pressure water inlets are formed in both the laser-water coupling device (2) and the annular water jet device (3).

14. A method of using the annular water curtain combined water-jet guided laser machining device according to claim 10, wherein a laser emitting device configured for emitting the laser beam (1) into the laser-water coupling device (2) is arranged at an upper end of the laser-water coupling device (2).

15. A method of using the annular water curtain combined water-jet guided laser machining device according to claim 10, wherein the laser beam (1) includes a single energy beam or a combination energy beam.

16. A method of using the annular water curtain combined water-jet guided laser machining device according to claim 10, wherein a diameter of the laser guiding water jet (6) is in a range of 10-600 μm, and a pressure of water is in a range of 0-100 MPa.

17. A method of using the annular water curtain combined water-jet guided laser machining device according to claim 15, wherein an inner diameter of the annular water curtain (7) is in a range of 2 mm to 50 mm, a flow width of the annular water curtain is in a range of 30 μm to 8 mm, and a flow rate of the annular water curtain is in a range of 0.01 to 10 times of a flow rate of the laser guiding water jet (6).

18. A method of using the annular water curtain combined water-jet guided laser machining device according to claim 10, wherein the high-pressure water includes purified water, distilled water, or other liquids meeting requirements for guiding laser.
